(19) United States
(12) Patent Application Publication
(10) Pub. No.: US 2012/0293567 A1
(43) Pub. Date: Nov. 22, 2012

(54) DISPLAY DEVICE

(75) Inventors: Masayuki Katagami, Osaka-shi (JP); Atsushi Ban, Osaka-shi (JP); Toshihide Tsubata, Osaka-shi (JP); Takehisa Yoshida, Osaka-shi (JP)

(73) Assignee: SHARP KABUSHIKI KAISHA, Osaka-shi, Osaka (JP)

(21) Appl. No.: 13/522,774

(22) PCT Filed: Oct. 26, 2010
(86) PCT No.: PCT/JP2010/069004

§ 371 Date: Jul. 18, 2012

(30) Foreign Application Priority Data
Jan. 28, 2010 (JP) 2010-017213

(51) Int. Cl. G09G 5/10

(52) U.S. Cl. 345/690

(57) ABSTRACT

The present invention provides a display device having color display dots with improved brightness and being excellent in visibility. The display device of the present invention comprises a pixel including an odd number of and at least three first sub pixels; and second sub pixels having a higher brightness than the first sub pixels, wherein units of the odd number of first sub pixels are repeatedly arranged, the second sub pixels are sequentially arranged along the arrangement direction of the first sub pixels, and the second sub pixels and at least one of the first sub pixels are alternately arranged in a direction perpendicular to the arrangement direction of the first sub pixels.

### TECHNICAL FIELD

The present invention relates to a display device. More specifically, the present invention relates to a display device suitably used in a bright environment such as outdoors.

### BACKGROUND ART

Display devices such as liquid crystal display devices and EL display devices are used in various fields utilizing their respective features. Specifically, active-matrix display devices including TFTs as pixel switching elements (driving elements) are used for monitors of PCs and mobile TV devices because of its high performance such as high contrast ratio and quick response speed, leading to a significant growth in its market.

Such display devices are strongly demanded to have sufficient visibility especially in a bright environment such as outdoors. As an application of liquid crystal display panels other than use in TVs, electronic posters are now considered. In such an application, display devices are required to have features that displayed images are visible even in a bright environment such as outdoors.

A transflective liquid crystal display device is disclosed in which a pixel includes three color sub pixels and a fourth sub pixel aligned laterally and each color sub pixel has a colorless sub segment (Ws), as illustrated in FIG. 19 of Patent Literature 1 (see Patent Literature 1). Also disclosed is a display including repeating units of sub pixels of specific colors (see Patent Document 2).

### CITATION LIST

### Patent Literature

Patent Literature 1: JP-A 2007-183569

Patent Literature 2: JP-T 2007-532949

### SUMMARY OF INVENTION

### Technical Problems

The above display devices are aimed to provide transflective liquid crystal display devices capable of improving the reflectance of pixels under conditions which may not significantly lower the color quality of liquid crystal panels, and to provide a method for improving the display quality. For that purpose, Patent Literatures only disclose that they are simply provided with colorless sub segments (Ws), and do not mention about Ws driving when light is on. Moreover, in the above display devices, the monochromatic brightness is not improved with an aim of improving the visibility.

Namely, the above display devices can be still improved to have excellent visibility as follows. In the case of display under an intense external light such as outdoor display, a display device having a RGB (red/green/blue) arrangement as illustrated in FIG. 6 problematically shows images dark. Recently, a RGBW (red/green/blue/white) arrangement as illustrated in FIG. 7 is proposed for use in electronic papers. In this case, if sub pixels (e.g. W dots) having a high brightness are arranged next to the color display dots for making image displayed brighter, as in the conventional case, a unit arrangement includes an even number (four) of dots. In such a case, the same color display dots may have the same polarity (e.g. R dots and B dots are all “+” and G dots are all “−”) to increase a circuit load, or to cause flicker.

A 4-color-dot display device (including W dots) as illustrated in FIG. 7 has more signal wirings to reduce the area per dot. Moreover, sub pixels having a high brightness increase the brightness during the white display mode. Then, if a monochromatic pattern is displayed on a white background, the monochromatic pattern having relatively lower brightness may appear dark and somber.

The present invention has been devised in consideration of the state of the art, and aims to provide a display device having color display dots with improved brightness and being excellent in visibility.

### Solution to Problem

The present inventors have studied about display devices excellent in visibility, and focused on the arrangement of sub pixels having a high brightness. They found out that improvement in each monochromatic brightness by sub pixels having a high brightness allows excellent visibility. They further found out that it is possible to improve the visibility of the display device by arranging sub pixels having a high brightness sequentially along the arrangement direction of an odd number of sub pixels and alternately arranging the sub pixel having a high brightness and at least one of the odd number of sub pixels in a direction perpendicular to the arrangement direction of the odd number of sub pixels. In this manner, they solved the above problems, thereby completing the present invention.

The present invention is a display device comprising a pixel including an odd number of and at least three first sub pixels; and second sub pixels having a higher brightness than the first sub pixels, wherein units of the odd number of first sub pixels are repeatedly arranged, the second sub pixels are sequentially arranged along the arrangement direction of the first sub pixels, and the second sub pixels and at least one of the first sub pixels are alternately arranged in a direction perpendicular to the arrangement direction of the first sub pixels.

In human visions, color change of some colors is easily sensible, while color change of other colors is not easily sensible. For example, color change of G color is less sensible compared to that of R color or B color. Pixels are arranged as illustrated in FIG. 1. Namely, units of the odd number of first sub pixels are repeatedly arranged. The second sub pixels are sequentially arranged along the arrangement direction of the first sub pixels. The second sub pixel and at least one of the first sub pixels are alternately arranged in a direction perpendicular to the arrangement direction of the first sub pixels (e.g. pixel arrangement in which W sub pixels are sequentially arranged along the arrangement direction of respective sub pixels of RGB colors and the respective RGB sub pixels and the W sub pixels are alternately arranged in the direction perpendicular to the arrangement direction of the RGB sub pixels), as illustrated in FIG. 1. In the case where the external light is strong, the second sub pixel is lit a little to increase the monochromatic brightness. Such a configuration of the display device of the present invention sufficiently improves the monochromatic brightness of each color, so that the resulting visibility is excellent.

Moreover, in the display device of the present invention, units of the odd number of first sub pixels are repeatedly arranged in the lateral direction in FIG. 1. Namely, the monochromatic display dots do not have the same polarity, suppressing increase in a circuit load.

The arrangement of the second sub pixels along the arrangement direction of the first sub pixels is preferably an arrangement of the second sub pixels substantially in parallel with the arrangement direction of the first sub pixels. Moreover, the second sub pixels are preferably arranged substantially in contact with the first sub pixels. The sequential arrangement refers to an arrangement of the second sub pixels without sandwiching another sub pixel therebetween at least in a part of the arrangement along the arrangement direction of the first sub pixels. The direction perpendicular to the arrangement direction may be a direction representing a perpendicular in the technical field of the present invention, and may be substantially perpendicular.

The configuration of the display device of the present invention is not especially limited as long as it essentially includes such components. The display device may or may not include other components.

Preferable embodiments of the display device of the present invention are mentioned in more detail below.

According to a preferable embodiment of the display device of the present invention, the second sub pixels in a pixel are divided into the same number of sub pixels as the first sub pixels and each divided sub pixel is provided with a thin film transistor element.

If the embodiment where the second sub pixels (e.g. W sub pixels) are divided is applied to the pixel arrangement in which an odd number of first sub pixels are each arranged in combination with a second sub pixel as illustrated in FIG. 1, the number of gradations in total in all the W sub pixels is increased (precise display is enabled as the number of gradations can be adjusted in each segment of divided W sub pixels). Therefore, for example, even in the case where the brightness of the W pixel is added to the B pixel that commonly has about 1/10 brightness of that of the W sub pixel, smooth gradation is realized, so that the resulting display device has better display quality. According to a preferable embodiment of the display device of the present invention, the number of the first sub pixels is three. The first sub pixels each are commonly a dot displaying a single color (herein also referred to as a color display dot). In particular, they are preferably fundamental color display dots (R, G, and B).

According to a preferable embodiment of the display device of the present invention, the second sub pixels are also lit in the pixel in monochromatic display. This improves the brightness of desired sub pixels in monochromatic display (display of a color close to a fundamental color), so that the visibility is improved.

The aforementioned modes of the embodiments may be employed in appropriate combination as long as the combination is not beyond the spirit of the present invention.

### Advantageous Effects of Invention

According to the display device of the present invention, the brightness of each sub pixel is improved, so that the visibility is improved.

### BRIEF DESCRIPTION OF DRAWINGS

[FIG. 1]

FIG. 1 is a schematic plan view illustrating a pixel arrangement in a present embodiment.

[FIG. 2]

FIG. 2 is a graph showing a relation between x values and Y values in the case where a part of W sub pixels are also lit when R and G colors are lit in the display device of the present embodiment.

[FIG. 3]

FIG. 3 is a schematic plan view illustrating a circuit board in the present embodiment.

[FIG. 4]

FIG. 4 is a schematic perspective exploded view illustrating the configuration of a liquid crystal panel shown in the present embodiment.

[FIG. 5]

FIG. 5 is a schematic perspective exploded view illustrating the configuration of a liquid crystal display device including the liquid crystal panel shown in FIG. 4.

[FIG. 6]

FIG. 6 is a schematic view illustrating a pixel arrangement in a conventional three-color panel.

[FIG. 7]

FIG. 7 is a schematic view illustrating a pixel arrangement in a conventional four-color panel.

[FIG. 8]

FIG. 8 is a graph showing relations between x values and Y values in a display device including a conventional three-color panel and in a display device including a conventional four-color panel.

[FIG. 9]

FIG. 9 is a graph showing brightness curves in the case where W sub pixels are also lit in monochromatic display in the display device having a pixel arrangement shown in FIG. 1 and in the display device having a pixel arrangement shown in FIG. 7.

### DESCRIPTION OF EMBODIMENTS

The monochromatic display herein refers to display of a color selected from three fundamental colors (RGB).

Provided with a TFT in an embodiment, a circuit board is also referred to as a TFT-side board. Provided with a color filter (CF) in an embodiment, a board opposing the circuit board is also referred to as a CF-side board.

The present invention will be mentioned in more detail referring to the drawings in the following embodiments, but is not limited to these embodiments.

### Embodiment 1

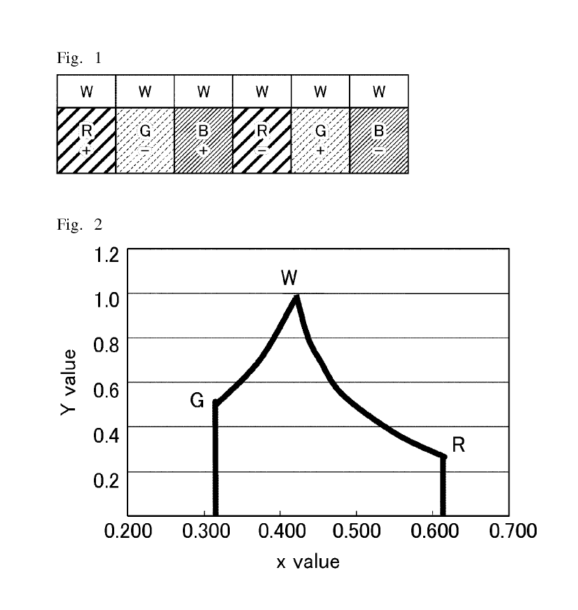

FIG. 1 is a schematic plan view illustrating a pixel arrangement in the present embodiment. The display device of the present invention comprises three first sub pixels (R sub pixel, G sub pixel, and B sub pixel) and a W sub pixel having a higher brightness than the three first sub pixels.

As illustrated in FIG. 1, in the liquid crystal display device of the present embodiment, units of RGB sub pixels are repeatedly arranged and W sub pixels having a higher brightness than the RGB sub pixels are sequentially arranged substantially in parallel with the arrangement direction of the RGB sub pixels (arrangement of an odd number of sub pixels in a lateral direction). Moreover, in the direction perpendicular to the arrangement direction of the RGB sub pixels, a W sub pixel having a high brightness and at least one of the RGB sub pixels are alternately arranged. This allows each of the RGB sub pixels to have a better brightness in monochromatic display, resulting in excellent visibility. In addition, a TFT element is connected to each of the RGBW sub pixels. The W sub pixels divided into three sub pixels and each divided sub pixel is provided with a TFT element, so that the number of gradations in the W sub pixel is increased to enable lighting of the W sub pixel at a low gradation level. This realizes smooth gradation.

In the case of monochromatic display in the present structure, additional lighting of the W sub pixels at a low gradation level can increase the monochromatic brightness. In other words, the W sub pixels may be lit in the monochromatic display to increase the monochromatic brightness. In the display device of the present embodiment, units of the odd number of sub pixels are arranged in a lateral direction. Therefore, even in the monochromatic display as shown in FIG. 1, the polarity of the sub pixels are not all the same (both + and − are exhibited), leading to a small circuit load.

The area of three first sub pixels (color display dots) in a single pixel in the present embodiment is preferably larger than the area of the second sub pixels. The area ratio of the three first sub pixels and the second sub pixels in a single pixel is more preferably 5:4 to 10:1. The area ratio is still more preferably 4:3 to 9:1 and particularly preferably 3:2 to 5:1. If the area of the first sub pixels is too large, the brightness may not be sufficiently improved. If the area of the first sub pixels is too small, the saturation may be significantly lowered or smooth gradation is not sufficiently achieved.

The area ratio refers to a ratio between the total area of three first sub pixels and the total area of the second sub pixels, namely, (total area of three first sub pixels):(total area of the second sub pixels).

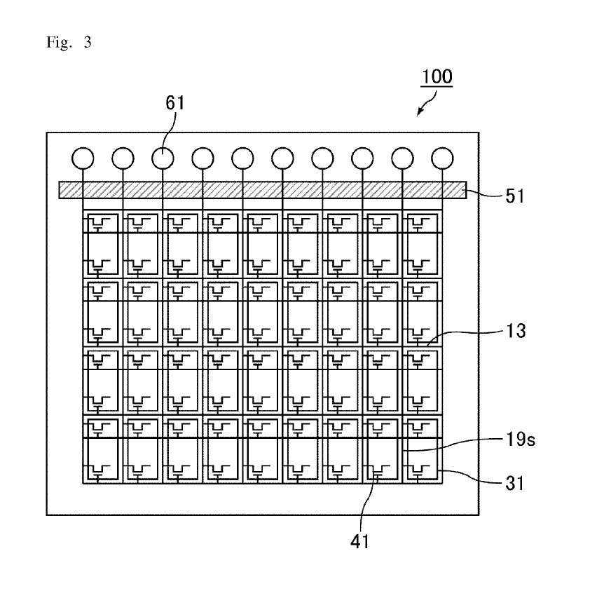

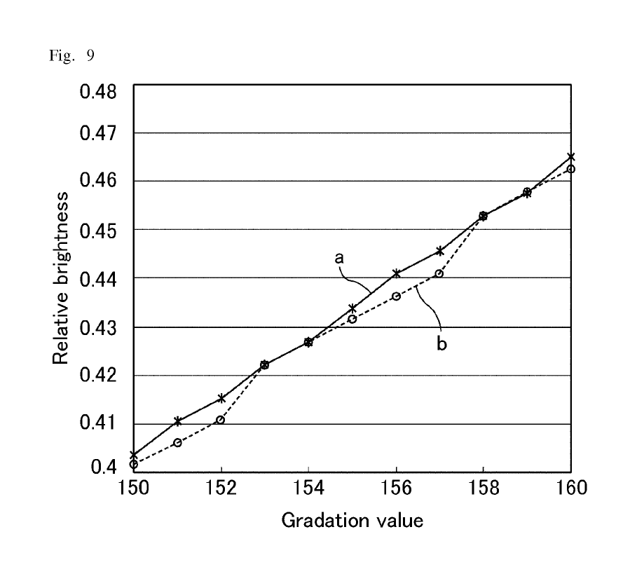

FIG. 2 is a graph showing a relation between x values and Y values in the case where a part of W sub pixels are also lit when R and G colors are lit in the display device of the present embodiment. FIG. 2 indicates that, in the case where W sub pixels are arranged along the color display dots as in the present embodiment, partial lighting of the W sub pixels when R and G colors are lit significantly covers the insufficient brightness of a color close to a fundamental color. For illustration purposes, FIG. 2 indicates a relation between x values and Y values of colors exhibited by lighting of the R sub pixels and G sub pixels only. The same shall apply to FIG. 8 illustrating cases of Comparative Examples 1 and 2 described later.

FIG. 3 is a schematic plan view illustrating a circuit board in the present embodiment. A circuit board 100 is a TFT-side board provided with a thin film transistor (TFT) 41 and has an area where a pixel electrode is arranged (display area) and an area outside of the display area (non-display area). In the non-display area, a connecting portion 51 and a terminal portion 61 are, for example, provided. Via the connecting portion 51, a source driver can be mounted on the circuit board 100 in the chip-on-glass system. Moreover, via the terminal portion 61, a flexible printed circuit board (FPC) can be mounted on the circuit board 100. For example, a signal for driving the source driver can be inputted from FPC through the terminal portion 61 and the connection portion 51.

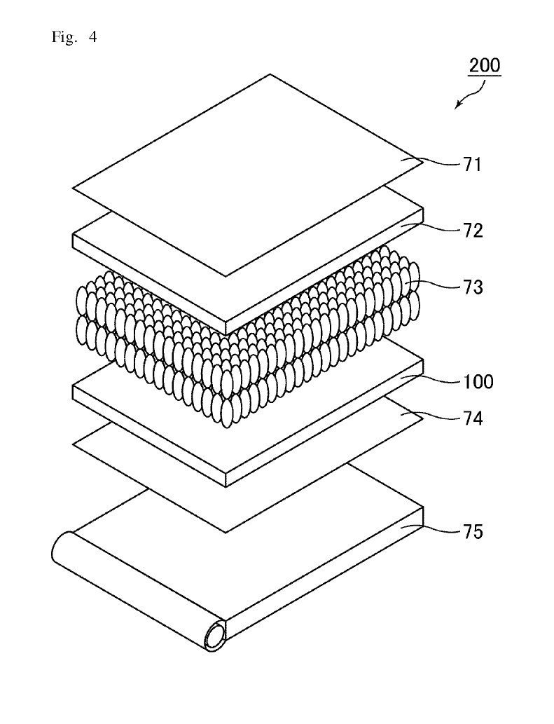

FIG. 4 is a schematic perspective exploded view showing the configuration of a liquid crystal panel shown in the present embodiment. As illustrated in FIG. 4, liquid crystals 73 are sandwiched between a CF-side board 72 and the circuit board 100 in a liquid crystal panel 200. The liquid crystal panel 200 is provided with a backlight 75 on the back side of the circuit board 100. The light of the backlight 75 passes through a polarizer 74, the circuit board 100, the liquid crystals 73, the CF-side board 72, and a polarizer 71 in this order. Whether the light passes or not is controlled by alignment control of the liquid crystals.

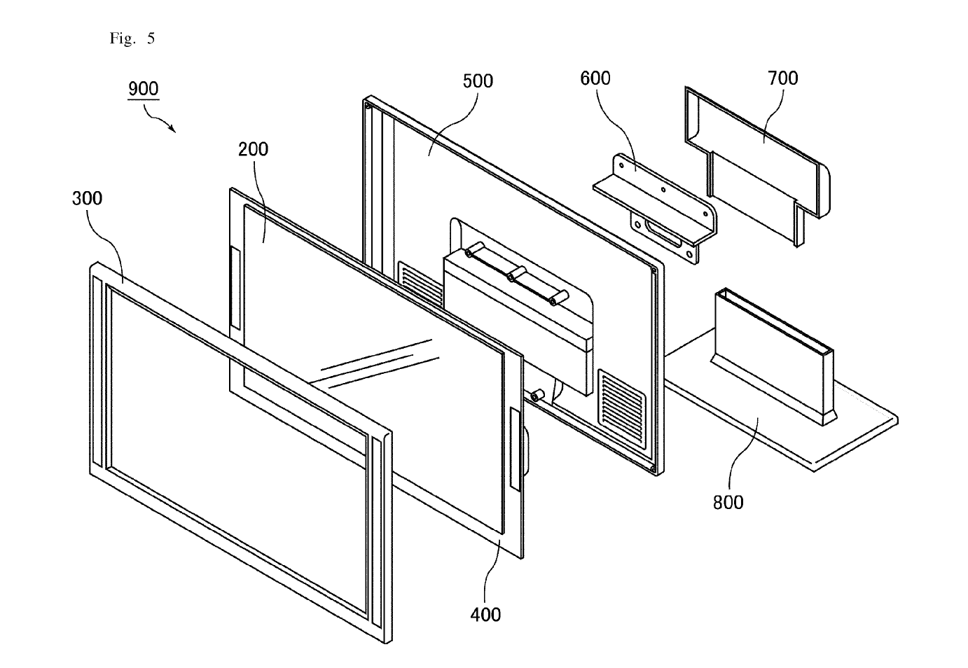

FIG. 5 is a schematic perspective exploded view illustrating the configuration of a liquid crystal display device including the liquid crystal panel shown in FIG. 4. As illustrated in FIG. 5, the liquid crystal panel 200 is fixed on a fixing panel 400 and enclosed in a front cabinet 300 and in a rear cabinet 500. The rear cabinet 500 and an upper stand 700 are fixed together with a metal fitting 600. The upper stand 700 and the lower stand 800 are combined.

The display device of the present invention may be a liquid crystal display device or an organic EL display device. In the case of a liquid crystal display device, each color is commonly displayed by a color filter transmitting light from a light source. In the case of an EL display device, each color is displayed by emission of emissive materials enclosed between the boards. Though FIGS. 4 and 5 each illustrate a configuration of a liquid crystal display device, the present invention is not limited to these and the same effects can be obtained in EL display devices such as organic EL display devices and inorganic EL display devices.

### Comparative Example 1

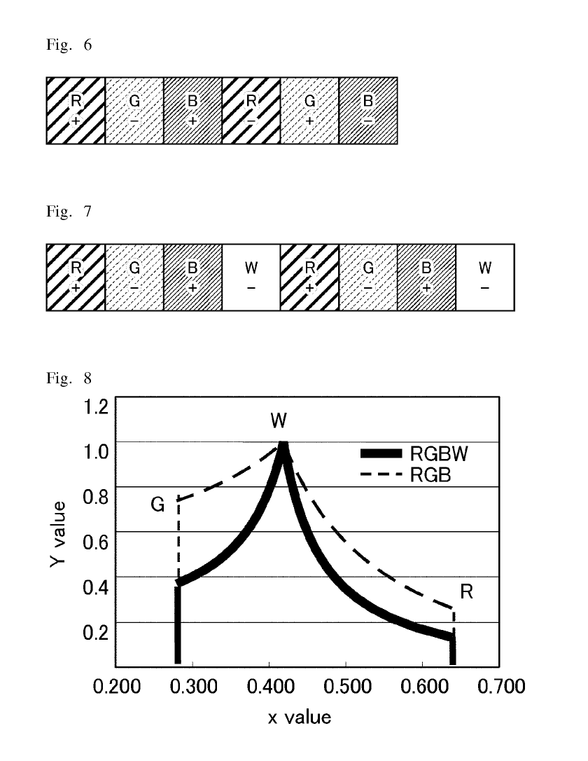

FIG. 6 is a schematic view illustrating a pixel arrangement in a conventional three-color panel. Since second sub pixels are not provided in FIG. 6, the brightness of color display dots cannot be sufficiently increased.

### Comparative Example 2

FIG. 7 is a schematic view illustrating a pixel arrangement in a conventional four-color panel. Arrangement of an even number of sub pixels as illustrated in FIG. 7 makes the sub pixels of each color have the same polarity, leading to an increased circuit load.

FIG. 8 is a graph showing relations between x values and Y values in a display device including a conventional three-color panel and in a display device including a conventional four-color panel. The graph shows that, in a four-color panel (RGBW), the white level is so high but the brightness (Y values) of G and R colors are lowered in display of a color close to a fundamental color.

FIG. 9 is a graph showing brightness curves in the case where W sub pixels are also lit in monochromatic display in the display device having a pixel arrangement shown in FIG. 1 and in the display device having a pixel arrangement shown in FIG. 7. The brightness curve of the display device having the pixel arrangement as illustrated in FIG. 1 is indicated by “a” and the brightness curve of the display device having the pixel arrangement as illustrated in FIG. 7 is indicated by “b”. In FIG. 7, W is arranged in alignment with color display dots (next to B) and has the same size same as the B sub pixel. Then, the brightness of the W sub pixel is high as about 10 times of the brightness of the B sub pixel at the same gradation level. Accordingly, upgrading of the gradation level of the BW pixels by one level significantly increases the brightness and the relation between the gradation and the brightness is not a smooth linear relation as indicated by “b” in FIG. 9. Arrangement of W sub pixels along the arrangement of color display dots and trisection of the W sub pixel makes the W brightness load to the B sub pixel smooth as indicated by “a” that is more linear than “b” in FIG. 9, resulting in smooth gradation.

The aforementioned modes may be employed in appropriate combination as long as the combination is not beyond the spirit of the present invention.

The present application claims priority to Patent Application No. 2010-017213 filed in Japan on Jan. 28, 2010 under the Paris Convention and provisions of national law in a designated State, the entire contents of which are hereby incorporated by reference.

### REFERENCE SIGNS LIST

13 Gate wiring

19s Source wiring

31 Sub pixel electrode

41 TFT element

51 Connecting portion

61 Terminal portion

71, 74 Polarizer

72 CF-side board

73 Liquid crystals

75 Backlight

100 Circuit board

200 Liquid crystal panel

300 Front cabinet

400 Fixing panel

500 Rear cabinet

600 Metal fitting

700 Upper stand

800 Lower stand

900 Liquid crystal display device

1. A display device comprising
a pixel including an odd number of and at least three first sub pixels; and second sub pixels having a higher brightness than the first sub pixels,
wherein units of the odd number of first sub pixels are repeatedly arranged,
the second sub pixels are sequentially arranged along the arrangement direction of the first sub pixels, and
the second sub pixels and at least one of the first sub pixels are alternately arranged in a direction perpendicular to the arrangement direction of the first sub pixels.

2. The display device according to claim 1,
wherein the second sub pixels in a pixel are divided into the same number of sub pixels as the first sub pixels and each divided sub pixel is provided with a thin film transistor element.

3. The display device according to claim 1,
wherein the number of the first sub pixels is three.

4. The display device according to claim 1,
wherein the second sub pixels are also lit in the pixel in monochromatic display.
